(19) United States
(12) Patent Application Publication
(10) Pub. No.: US 2012/0180818 A1
(43) Pub. Date: Jul. 19, 2012

(54) SUBTERRANEAN CHAMBER WATERPROOFING SYSTEM

(76) Inventor: Lawrence M. Janesky, Seymour, CT (US)

(21) Appl. No.: 13/428,823

(22) Filed: Mar. 23, 2012

Related U.S. Application Data
(63) Continuation of application No. 11/673,883, filed on Feb. 12, 2007.

(51) Int. Cl. E04B 1/64; B08B 9/027

(52) U.S. Cl. 134/22.11; 52/302.3

(57) ABSTRACT

An elongate drainage conduit section comprises a channel portion having at least one perforated surface allowing liquid to flow into the channel, and at least one lower surface for directing the flow of water in a lengthwise direction. The conduit further comprises an elongate, movable cover for sealing at least a portion of the top of said channel portion.

### CROSS REFERENCE TO RELATED APPLICATION(S)

This application is a continuation of U.S. patent application Ser. No. 11/673,883, filed on Feb. 12, 2007, the disclosure of which is incorporated by reference herein in its entirety.

### BACKGROUND

1. Field

The present embodiments relate to drainage systems and, more particularly, to subterranean chamber waterproofing systems.

2. Brief Description of Related Developments

Various types of systems have been devised to drain water from the perimeter of a basement floor. Systems range from the simple installation of drainage tile or pipe below floor level, to sophisticated application-specific water receiving conduit. Examples of the latter are disclosed in U.S. Pat. No. 5,501,044, incorporated herein by reference. Such water receiving conduit may, for example, have a tubular portion forming a drain channel below floor level to direct water to a sump or discharge point. The tubular portion may have holes formed in a wall thereof to receive water into the tubular portion. The tubular portion may have a horizontal wall at the top thereof. A back wall or flashing may extend upward from the tubular portion against the basement wall, and may have spacer elements spacing the back wall of the conduit from the basement wall, to allow water to flow down the basement wall and into subfloor drain channel formed by the tubular portion, for example via hole(s) or openings(s) in the tubular portion. Cement or concrete may be applied directly atop the subfloor drain channel, the upper surface of the cement or concrete being at floor level and forming an exterior edge of the basement floor. The visual appearance of the basement after installation may be such that the floor extends over the tubular portion to the wall flashing of the conduit section.

Though most ground water that leaks into basements is “clean”, sometimes drains may become clogged with deposited material.

A particularly troublesome type of deposited material that may form in the basement drainage systems, as well as other types of ground water drainage systems, is iron ochre. Iron ochre typically forms when ferrous iron that is dissolved in drain water is oxidized by certain types of bacteria. The bacteria consist of long filaments, and combine with the oxidized iron to form a sticky matrix. Soil particles and other materials that would ordinarily pass through the drains become attached to this sticky material, further clogging the system and inhibiting water flow.

The problem also exists with other types of perimeter drainage systems, including systems having drainage tile or perforated pipe that is installed in a gravel filled channel. One possible solution is to provide localized access points that allow for flushing of the system with water, or hot water. This solution is useful in some cases, but in other cases may not be sufficient to clear out deposited material. Some conventional drainage systems may be cleaned by inserting a hose into a port provided in the drainage system, and attempting to flush the drains possibly in combination with trying to shake the hose through the drain system in order to bring the higher flush pressure at the hose head proximate the iron ochre deposits. Removal by flushing of the sticky mass formed by iron ochre in conventional drainage systems has achieved unsatisfactory results.

Moreover, if deposits have aged they may have become crystalline, yielding them resistant to cleaning with water flushing, even at high pressures or temperatures. Thus, iron ochre buildup in drainage systems has proven resistant to removal by conventional techniques. Acidic solutions can be used to break up the material by dissolving the iron, but the caustic solutions create environmental and health concerns. Acid solutions often cannot be used for the additional reason that materials forming the pipe or conduit may also be dissolved or otherwise damaged, including many types of polymer materials commonly used to construct drainage systems. The features of the exemplary embodiments overcome the problems of conventional systems as will be described in greater detail below.

### BRIEF DESCRIPTION OF THE DRAWINGS

The foregoing aspects and other features of the present embodiments are explained in the following description, taken in connection with the accompanying drawings, wherein:

FIG. 1 is schematic perspective view illustrating a known water receiving conduit installed in a perimeter drainage system.

FIG. 2 is a schematic perspective view of a drainage conduit according to one embodiment.

FIG. 3a is a cross-sectional view of a covering portion of the drainage conduit of FIG. 2.

FIG. 3b is a cross-sectional view of a water-conveying portion of the drainage conduit of FIG. 2.

FIG. 4 is a schematic cross-sectional view illustrating the drainage conduit of FIG. 2 installed in a subterranean chamber C.

FIG. 5 is cross-sectional view of a drainage conduit according to another exemplary embodiment.

FIG. 6 is a cross-sectional view of a drainage conduit according to yet another exemplary embodiment.

FIG. 7A is a perspective view of a conduit section having a single cover portion section.

FIG. 7B is a perspective view of a conduit section having more than one cover portion section.

FIG. 7C shows a perspective view of a conduit section having a both removable cover portion section and a fixed roof wall.

FIG. 8 shows a partial schematic perspective view of a conduit section in accordance with still another exemplary embodiment.

### DETAILED DESCRIPTION OF THE EXEMPLARY EMBODIMENTS

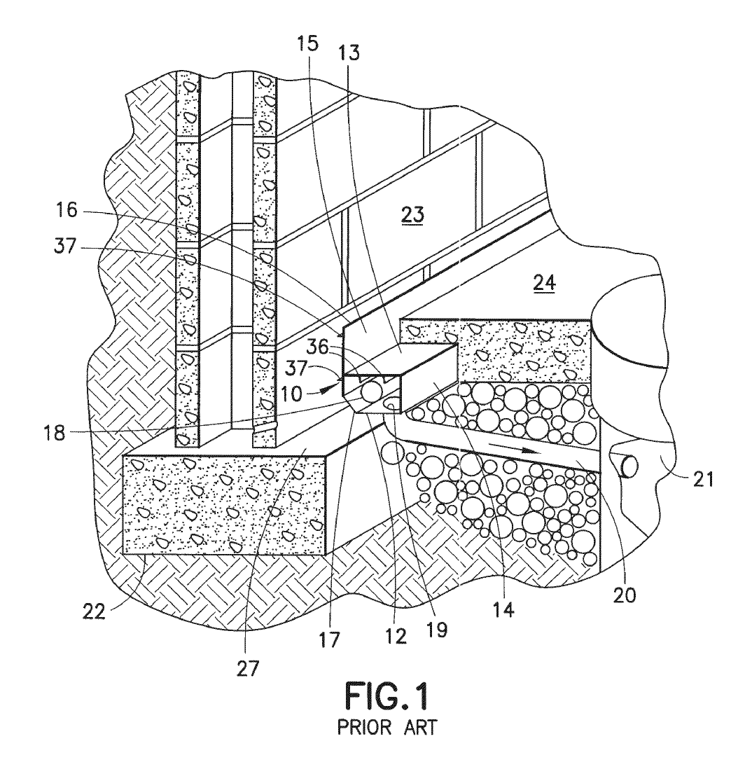

FIG. 1 shows a drainage conduit system 10 similar to that described in U.S. Pat. No. 5,501,044, which has been incorporated herein by reference. The drainage conduit system 10 is shown installed, for example, under the slab or floor 24 of a subterranean or partially subterranean room or chamber (e.g. a basement or crawlspace). As seen in FIG. 1, the conduit sections of system 10 may be seated on a foundation or footing 22 of the chamber wall 23. The conduit sections forming the system may be similar, with a lower, tubular portion 17 forming a drain channel designed to convey water along the length of the conduit while receiving water into the interior of the conduit via a series of regularly spaced openings 18 facing the block wall 23. The chamber concrete floor 24 may extend over and substantially cover the tubular portion 17. The conduit section may have a back wall or wall flashing 16 that extends upward from the tubular portion 17, along the wall 23. The wall flashing and tubular portion may be formed integrally, or separately (for example as described in U.S. patent application Ser. No. 11/211,421 incorporated by reference herein in its entirety) in extruded sections of polyvinyl chloride (PVC) or other material. The tubular portion may comprise a base floor wall 12, horizontal top or roof wall 13, outer wall 14, an inner wall 15. The outer edge of the concrete floor, covering the tubular portion, may be supported at least in part by the top or roof wall 13 of the conduit section. The wall flashing may extend above the floor 24. The conduit may direct water along its length. A hole 19 may be formed in the bottom of the tubular portion, and the tubular portion may be sealingly mated with a drain pipe 20 connected at the hole 19, to allow water to egress from the conduit. The drain pipe 20 may be installed with a slight grade, to direct flowing water from the conduit 10 into a sump 21. Water from the sump may be removed using a mechanical pump and directed outside of the basement.

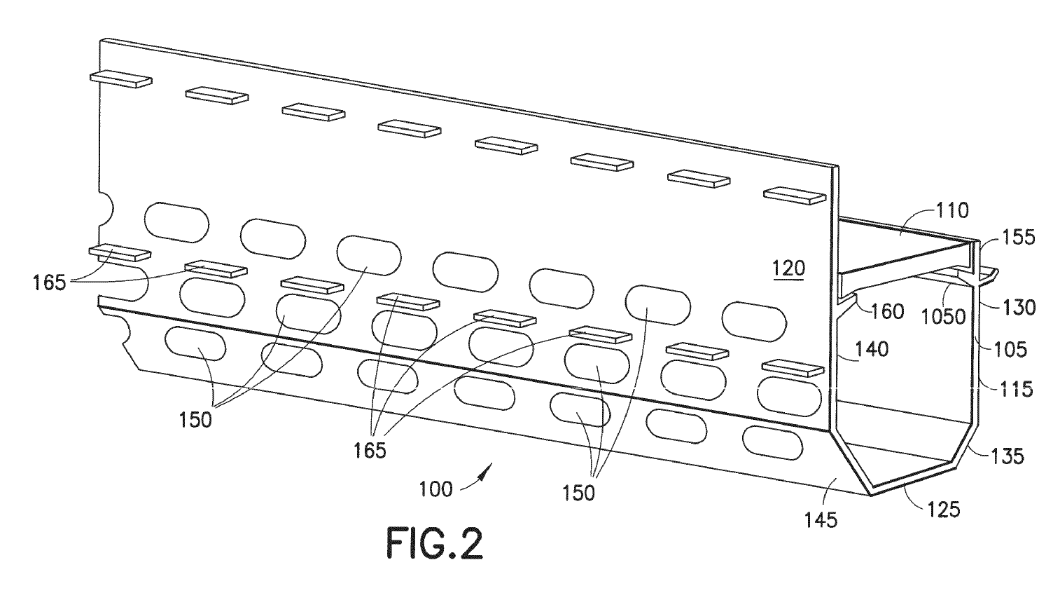

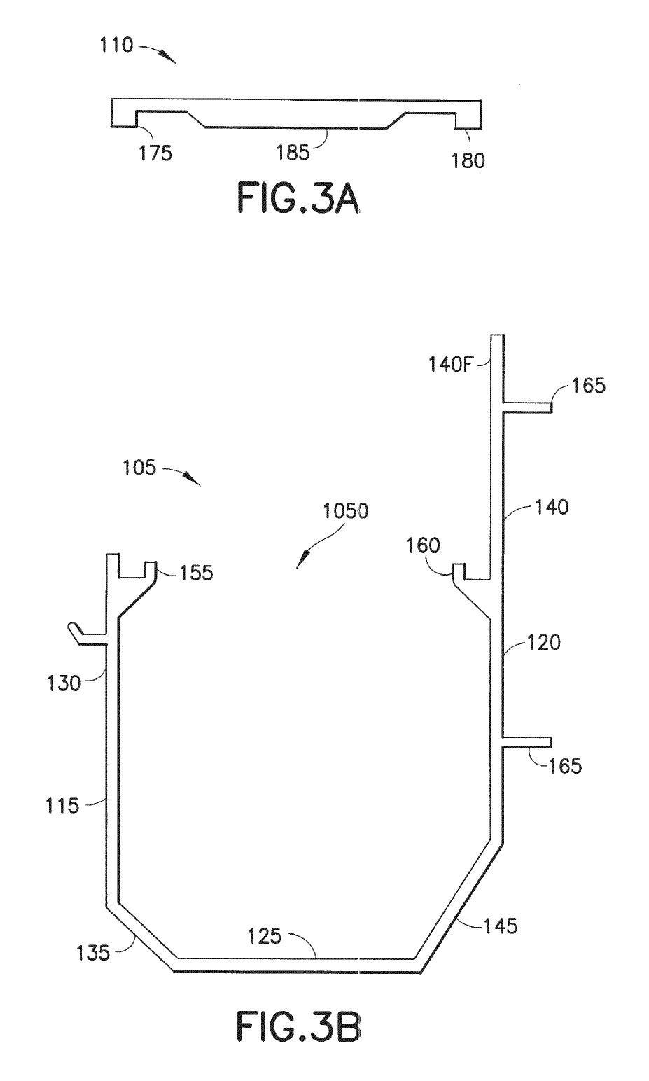

FIG. 2 shows a section of a drain conduit 100 according to an exemplary embodiment. Although the present embodiments will be described with reference to the exemplary embodiments shown in the drawings and described below, it should be understood that the present embodiments could be embodied in many alternate forms. In addition, any suitable size, shape, or type of elements or materials could be used. The conduit section 100 in the exemplary embodiment shown in FIG. 2, may be generally similar to the conduit sections of drain conduit system 10 described before and shown in FIG. 1, except as otherwise described in greater detail below. The conduit section 100 in FIG. 2 has features to facilitate ease of cleaning and inspection as will be further described. The conduit section may have a two part construction comprising a channel portion 105, adapted to receive and convey water, and a removable cover portion 110 that may open and close an opening 105O accessing the interior of the conduit when installed under the floor 24 of the chamber. The cover portion 110 is illustrated in cross section by FIG. 3a. FIG. 3b illustrates a cross section of the channel portion 105. In the exemplary embodiment the channel portion 105 may have a generally U-shaped cross section, though in alternate embodiments the channel portion may have any other suitable channel shape. The channel section may have a front channel wall 115, rear channel wall 120, and channel floor wall 125. In the exemplary embodiment the channel section 105 may be a one piece member of unitary construction. The channel section 105 may for example be a plastic extrusion or molding. In alternate embodiments the channel section may be formed from one or more members and may be made from any desired material(s). In the exemplary embodiment the front wall 115 may have an upper portion 130 (that is for example substantially upright, and a lower portion 135 that is sloped inward toward the floor wall. The front wall may have an outwardly projecting tab or stiffener arranged for example for stiffening the front wall 115 and engaging the chamber floor as will be described. The rear wall may also have both an upper portion 140 and a lower portion 145 that is sloped inward toward the channel floor wall. The inward-sloping portions 135, 145 form oblique angles with their adjoining walls, which may inhibit debris accumulation as compared to sharper angles. In the exemplary embodiment shown in FIGS. 2-3b, the upper portion 140 of the rear wall may have an extension (relative to the front wall 115) defining a wall flashing 140F when the conduit section 100 is installed.

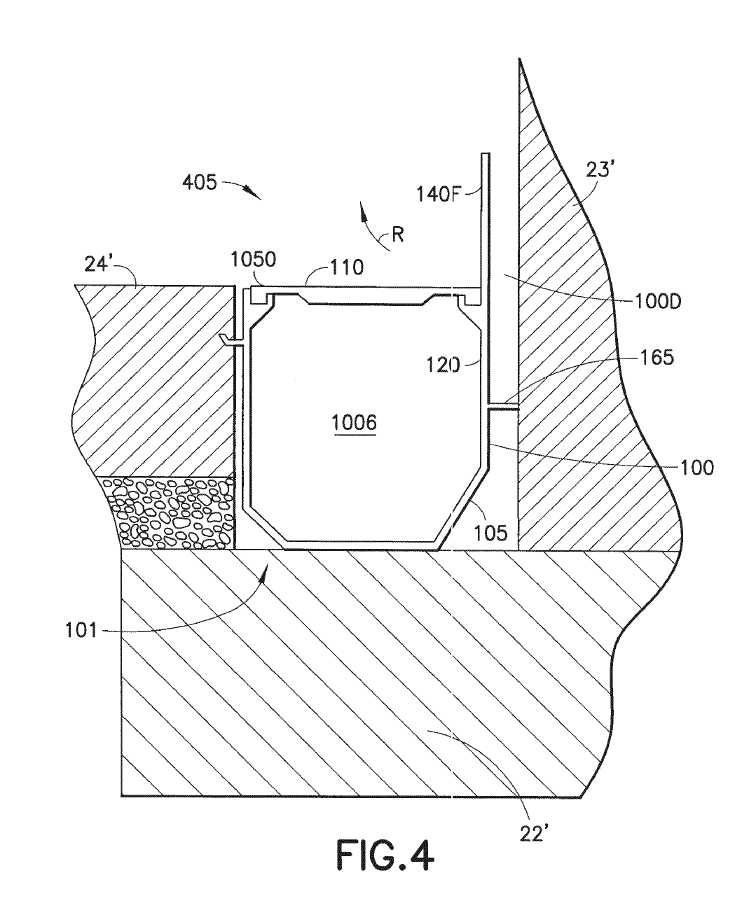

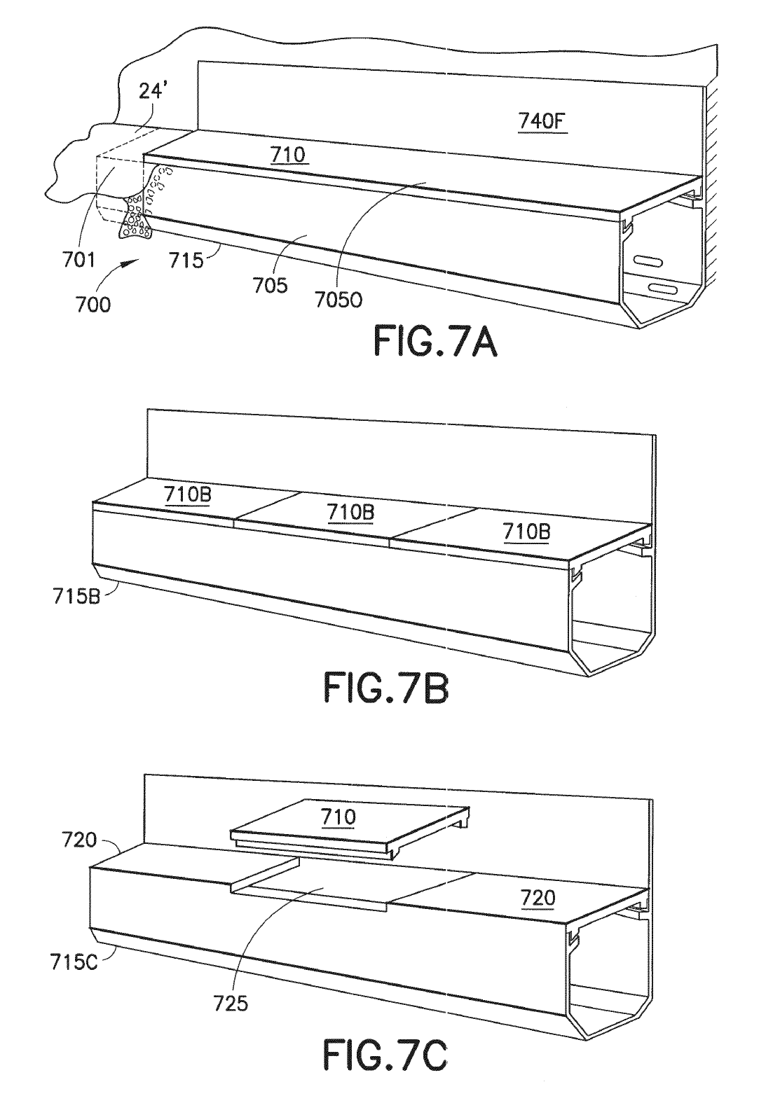

As seen best in FIG. 2, in the exemplary embodiment three (though in alternate embodiments there may be more or fewer) rows of spaced openings 150 are formed in the rear channel wall, to allow an inflow of water into the conduit from the region of the foundation around the conduit. In alternate embodiments there may be more or fewer openings arranged in more or fewer rows, other patterns, or any other suitable arrangement. In the exemplary embodiment, the lower row is located on the sloped lower portion 145 of the rear channel wall 120, and the two upper rows are located on the upper portion. Between the two upper rows, a row of spacer elements 165, in the example shown, may protrude rearward from the rear channel wall 120, to separate the rear wall for example from the wall of the basement (similar to wall 23 in FIG. 1, see also for example FIGS. 4A and 7A). The spacer elements 165 may be regularly spaced, with gaps between them to allow for a downward flow of water, through the openings 150 and into the conduit. In the exemplary embodiment, a similar row of regularly spaced elements may be formed near the top edge of the rear channel wall 120 on wall flashing 140F. Alternate embodiments may be provided with spacer elements in any other suitable arrangement, or with no spacer elements.

As may be realized from FIGS. 2-3B, and seen best in FIG. 4, the front and rear channel walls 115, 120 define access opening 105O, that allows access to the interior of the subfloor conduit when installed as will be described further below, and is closed by cover 185. In the exemplary embodiment, the front channel wall 115 has a lip or detent 155 formed thereon, to interface with the cover portion 110. The rear channel wall also has a lip or detent 160 extending therefrom. In the exemplary embodiment, the rear lip 160 is substantially similar but opposite to the lip 155 on the front channel wall, and above the openings 150 that are located in the rear wall for water inlet (see FIG. 2). The cover portion may rest on the detents 155, 160 when in a covering or closed position. The detents 155, 160 may form surfaces for locating and supporting the cover portion 110 on the channel portion 105. As shown in FIG. 3a, the cover portion may also be provided with detent(s) 175, 180 adapted to cooperate and interface with the detents 155,160 of the channel portion. Each of the detents 155, 160 and 175, 180 may run longitudinally as desired along the conduit section. The cover portion 110 may be provided with a central portion 185 having an enhanced thickness, to inhibit bending of the cover portion. In the exemplary embodiment shown, the detents 155, 160 and cover portion 110 may be shaped such that the cover portion may snap onto the channel portion thereby locking the cover portion in its closed position. In alternate embodiments, the cover portion may simply rest on the detents 155, 160. The detents may locate the cover portion 110 on the channel portion so as to resist lateral movement of the cover portion in a direction away from the rear channel wall 120. In other alternate embodiments the detents on the channel section may have any other suitable configuration. In still other alternate embodiments, the channel section may not have engagement detents for the cover portion, and the cover portion may include contact surfaces that frictionally hold the cover portion on the channel portion when closed.

FIG. 4 shows the water receiving conduit of FIG. 2 installed in an at least partially subterranean chamber for example generally similar to the chamber shown in FIG. 1 (similar features are similarly numbered). More specifically, FIG. 4 illustrates representative channel section 100 of a basement drainage conduit system 101. The chamber may have a wall 23′, (for example formed of concrete block, poured concrete, brick, mortared rock, or any other suitable material). The chamber may also have a floor 24′, which forms a joint 405 with the wall 23′ (the floor 24′ for example being formed of poured concrete, tile, or of any other suitable material, and may be of a multi-layer construction, for example a concrete subfloor having carpeting, linoleum, or other floor finishing material applied over it, either directly or with an intermediate layer, such as plywood over regularly-spaced joists with the joists supported by the concrete subfloor). The drain conduit 101 may be installed along the entire length of the joint between the basement wall 23′ and basement floor 24′, or along any portion thereof. As seen in FIG. 4, in the exemplary embodiment, the conduit section 100 is positioned on the wall footing 23′ when installed. The conduit section and conduit system may be installed prior to installation of the floor 24′, or may be retrofitted after floor installation, for example in accordance with U.S. Pat. No. 5,501,044 incorporated by reference herein in its entirety. In alternate embodiments the conduit section may be installed in any other suitable manner or position under the floor. In the exemplary embodiment, tab 132 on the front wall 115 of the channel section may be embedded into the chamber floor 24′ (e.g. by using the front wall of the drain channel as a form when pouring/forming the adjacent section of the floor 24′) thereby locking the front wall 115 of the channel section 105. This results in great stability of the channel section wall(s) such as when opening and closing cover 110, or any other loading condition. The installed conduit section 100 defines a subfloor drain channel 100C as shown. The rear spacer 165, shown in the exemplary embodiment in contact with wall 23′ when the conduit section 100 is installed, result in the conduit section forming another drain channel or passage 100D. Passage 100D, as noted before, allows passage of for example, water, to move along the surface of the wall 23′ and enter drain channel 100C via opening 105 (see also FIG. 2). As has also been noted before, in alternate embodiments, the rear of the drain channel section may be located flush against the wall surface. The conduit system may be laid down or installed by serially placing multiple sections of drain channel along the desired length of floor joint. In the exemplary embodiment, the sections may be joined together, for example, by securing ends of the respective drain channel sections with a suitable connector element (not shown), or an adhesive. If desired, each drain channel section of the conduit may be generally similar to section 100 having a channel portion 105 and corresponding section of movable cover portion 110. Thus, if desired, substantially the entire length of the conduit along the floor joint may be accessible for inspection or cleaning of the interior of the conduit, and then covered again after the desired cleaning, inspection, or other operation is completed as will be described further below. In addition, if it is desired to access only select portions along the joint, only corresponding cover portion sections may be removed, while other cover portion sections remain in place. In alternate embodiments, the drain conduit system may include both openable sections, similar for example to drain channel section 100, and drain channel sections that cannot be opened.

The conduit system when installed may have one or more locations along its length at which water is allowed to discharge from the conduit. For example, at a discharge location (not shown), a drain channel section such as a section similar to section 100, may be mated to a discharge tube, for example via an opening in the floor wall of the channel piece (see also FIG. 1) allowing for an egress of water from the conduit. The drain tube or tubes may feed into a sump, from which water may be removed via a mechanical pump. In other embodiments, the drainage system may be configured to allow the water to drain from the conduit and out of the basement by gravity feed to a stream, connection to municipal drain system, or any other suitable pathway. Because the water inlet holes 150 and floor wall 125 of the channel portion are below floor level, water can drain into the conduit without collecting on or flowing across the floor 24′. The spacer elements 165 on the rear of the rear channel wall 120 may maintain a gap between the rear channel wall 120 and the basement wall 23′. Gravel that may be provided on the underside and surrounding sides of the exterior of the conduit, below the floor 24′ and footing 22′ may, for example under poor foundation drainage conditions (e.g. soil saturation) allow ground water to flow into the basement between the footing 22′ and basement wall 23′, to be collected by the conduit system. Ground water may also enter the conduit, for example by flowing down the interior surface of the basement wall 23′, or flowing through the wall. The cap or passage 100D (see FIG. 4) between the rear wall 120 and basement wall 23′, may allow this water to flow downward and through the water inlet openings 150 at the rear of the conduit into the drain channel 100C. In alternate embodiments, basement walls may have pathways therein allowing for the flow of water. For example, gaps between rocks in a rock wall may allow water to flow through the wall from soil on the exterior side of the basement wall such as if mortar is missing or inadequate. Weep holes may be provided in some types of basement wall to allow water to drain from the wall. For example, concrete block may be formed with cavities on the interior of each block. Weep holes may be drilled into a concrete block wall to access these cavities and allow water to drain out of the interior of the wall and through the water receiving conduit.

In the exemplary embodiment shown in FIG. 4, the opening 105O of the conduit section 100 extends through the floor 24′ of the chamber. As may be realized from FIG. 4, removal or opening of closure or cover 110, results in the opening 105O providing an access way through the floor 24′ into the interior of drain conduit when the drain conduit section 100 is installed. The water receiving conduit may be installed such that the upper surfaces of the cover portions are substantially flush with an upper surface of the basement floor 410. Thus in the exemplary embodiment, when installed or closed, the cover portion sections may effectively form an extension of the floor 24′ along the edge of the floor at the floor joint 465. In the exemplary embodiment the opening 105O in the drain channel allows a person to view, and hence inspect, substantially for surfaces of the drain channel 105 as well as the inlet openings 150 through which passage 100D (between rear channel wall 120 and chamber/basement wall 23′) and the drain passage 100C of the drain conduit. Thus, by opening the cover section 110, a person may view substantially all the interior surfaces bonding the conduit drain passage 100C, the drain inlet holes 150 of the passage 100C and, through the holes 150, inspect the adjoining areas of passage 100D. Moreover, the access opening 105O penetrating through the basement floor 24′ as illustrated in the exemplary embodiment shown in FIG. 4, allows a person to manually access directly substantially all the surfaces of the drain passage 100C as well as the holes 150, through which the passage 100D, drains into the drain passage 100C. Thus, when the conduit system is installed, a person may open the cover section 110, and, if desired upon inspection, may reach in and manually or manumotively (i.e. with the person's hand or hand held tool) collect and remove any undesired buildup or residue materials (e.g. gel, paste, sludge) in passage 100C, along any of its surfaces, and in holes 150. In the exemplary embodiment, the opening 105O substantially exposes the entire channel 100C and a person may remove the residue buildup from the subfloor conduit by lifting it out (e.g. by hand or with handheld tool) through the access opening through the basement floor 24′ (in the direction indicated by arrow R in FIG. 4). The results of cleaning/removal may be visually determined freely, again via opening 105O, and the cleaning process of drain channel 105 and portions of passage 100D, may be continued substantially unrestricted by opening 105O until inspection reveals satisfactory condition. The cover section 110 may then be installed, closing the access opening 105O through the floor 24′. As may be realized, the resulting condition of drain conduit passages 100C, 100D that may be achieved by direct inspection and cleaning through access hole 105O are significantly superior than what may be achieved by remote cleaning via flushing by means of a hose snaked into the conduit as is conventionally performed.

Referring now to FIG. 7A; there is shown a schematic partial perspective view of a subfloor drain conduit system 700 in accordance with another exemplary embodiment. In the exemplary embodiment shown, the conduit system may include openable sections 705 and other subfloor drain channel sections 701. As shown in FIG. 7A in the exemplary embodiment the drain channel section 705 may be similar to drain channel 105 shown in FIG. 2 and may have a section 715 of channel portion 705 and removable cover 710. The channel portion section 715, including front channel wall 115 rear channel wall 120, detents 155, 160, and floor wall 125 may be formed together in extruded sections of polyvinyl chloride (PVC) or other polymer. In alternate embodiments, any suitable material may be used to form the channel piece, and other manufacturing methods may be employed. For example, aluminum sheeting may be appropriately pressed, stamped, cut and/or coated to form the desired channel piece, or fired clay, composite materials, or any other suitable material and method of manufacture may be used. The cover portion may be similarly be formed of extruded PVC or with other materials or methods. In the exemplary embodiment of FIG. 7A, a cover portion section 710 and channel portion section 715 are each formed of a single extruded PVC element of substantially identical length, such as in ten-foot length or any other suitable length. The width of the channel portion may be, in one example, roughly three inches, or may be any other suitable width. The installation of drain channel section 705 is generally similar to section 105 described before and shown in FIG. 4. The adjoining drain channel section(s) 701 of the conduit system 700 in the exemplary embodiment may be generally similar to drain channel sections 10 shown in FIG. 1. Section(s) 701 of the conduit system 700 may not have an opening extending through the floor 24′, such as opening 7050 of openable section 705. The floor 24′ may cover the drain channel section 701 however, as may be realized, the drain channel section(s) 701 of the conduit system, even if not openable themselves, may be accessed for visual inspection and cleaning via the opening 705O of section 705 (similar to opening 105O described before). The drain channel sections 701 may be inspected and cleaned via hole 705O in a substantially similar manner to that described before for drain section 105. The placement of openable and non-openable drain channels sections 705, 701 along the conduit system may be selected as desired. For example, the drain channel section 701, 705 may be placed and installed in a generally alternating manner so that inspection and cleaning of non-openable drain section 701 may be accomplished from an adjoining openable section such as section 705. The length of both sections may be varied as desired, for desired access for inspection and cleaning of the drain passages of the subfloor conduit.

In other embodiments, the cover portion may be formed in sections 710 of greater or lesser length than the channel portion sections 715. For example, the length of one channel portion section 715 may equal the length of two or three cover portion sections 710, allowing the conduit 100 to be open along its entire length or also to be opened along only half or a third of the length (see for example FIG. 7b). In still other exemplary embodiments, the channel portion may be permanently covered along some portions of its length. For example, the channel portion may have an integrally formed roof wall at either end of the channel piece section, with one or more portions along its length left uncovered to accept a cover portion as described above (see for example FIG. 7C). The uncovered portions of the channel piece may be provided with locating detents to accept the cover portions. FIG. 7A illustrates, in an exemplary embodiment, a conduit section in which a cover portion section 710 has substantially the same length as a channel portion section 715, so that the cover portion section covers substantially all of the channel portion section 715 when seated in a covering position on the channel portion section 715. FIG. 7B illustrates, in another exemplary embodiment, a conduit section having a single channel portion section 715B and more than one cover portion section 710B. The channel portion section may be uncovered along substantially all of its length by removing all of the cover portion sections 710B, or may be covered along substantially all of its length by locating each of the cover portion sections 715B in a covering position on the channel portion section 710B. In addition, a desired part of the channel portion section 715B may be accessed by removing only one or more of the cover portion sections 710B, while one or more of the other cover portion sections 710B remains in a covering position on the channel portion section 715B. The channel portion section 715B and each of the cover portion sections 710B may be for example each individually formed as a single, unitary structure of continuous material. FIG. 7C illustrates, in yet another embodiment, a conduit section wherein the channel portion section 715C has a permanent roof wall 720 covering the interior of the channel portion along a part of its length. The roof wall may be formed integrally with the channel portion section as a single, unitary structure of continuous material. In alternate embodiments, the roof wall 720 may be separately formed and secured to the channel portion using, for example, adhesive or fasteners. The channel portion section may also have a service aperture 725 (similar to opening 705O, 105O) at which there is no permanent roof wall 720. A cover portion section 710 may be adapted to fit the aperture 725, so as to close the channel portion section at the aperture. As may be realized, when conduit section 715C is installed, opening 725 forms a through floor access passage into the drain channel similar to that formed by opening 105O (see FIG. 4). In an alternate embodiment (not shown), a section of channel portion may be provided with integral roof walls spanning, for example, every other foot (or other desired channel length), with resulting one foot long uncovered sections therebetween to accept elongate cover portions. The roof walls and uncovered sections could also have any other suitable length. This may provide suitable access to the interior of the channel for inspection or cleaning of both the covered and uncovered portions. Other alternate embodiments may have still different constructions.

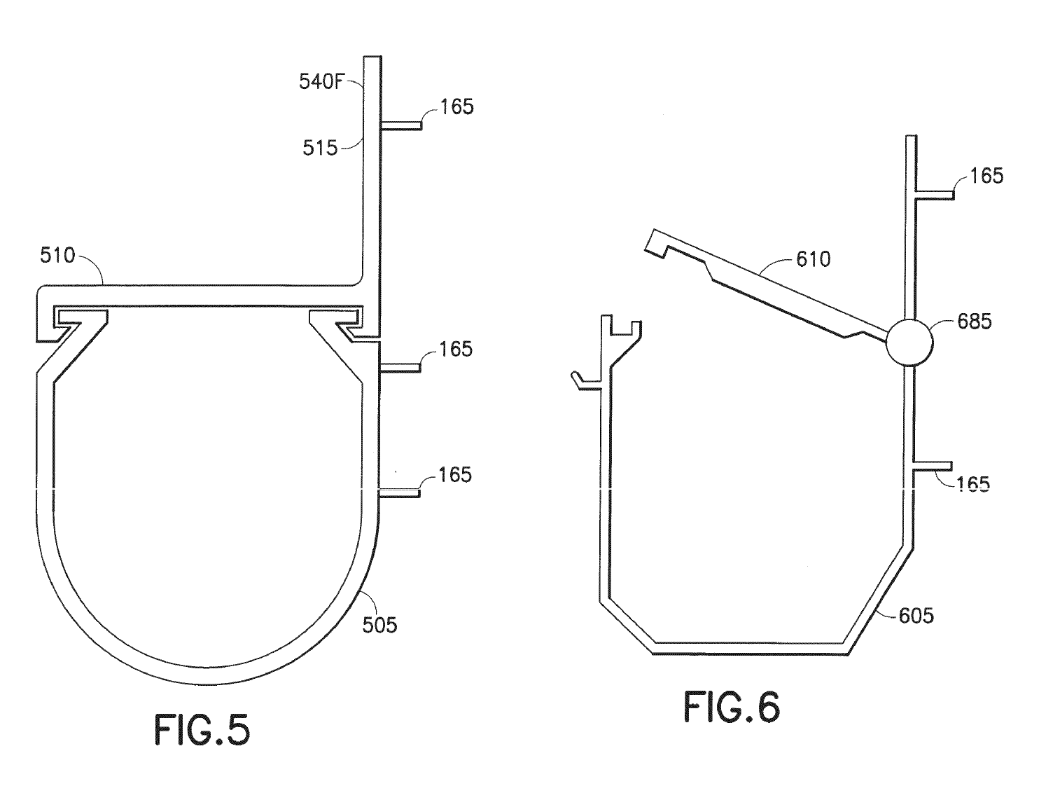

FIG. 5 illustrates a subfloor drain conduit according to another exemplary embodiment. Channel portion 505 may have a curved lower portion and substantially vertical front and back walls. The back wall of the channel portion may have spacer elements 165 thereon, similar to the spacer elements shown in FIG. 2. The conduit may also have a removable cover portion 510. The removable cover portion may be integral with a vertical back wall 515, and may be formed as a single, unitary member of continuous material. The back wall 515 may also have spacer elements 165 thereon and may be arranged to define a wall flashing 540F (when the drain section is installed) similar to flashing 140F described before and shown in FIG. 3B. Thus, when covering the channel portion 505, the cover portion 510 may also form an upper portion 515 of a back wall of the conduit. When the cover portion 510 is removed from the channel portion 505, the upper portion 515 of the back wall may also be removed. Interlocking detents, may be respectively provided on the cover and channel portion generally similar to those shown in FIGS. 3A-3B.

FIG. 6 illustrates another subfloor drain conduit according to still another exemplary embodiment. A channel portion 605 may have a hinge or flex portion 685 thereon. The channel portion 605 may otherwise be substantially the same as the channel portion 105 of FIGS. 2 and 3b. In the exemplary embodiment, a cover portion 610 may be movably connected, by hinge or flex portion 685, to the channel portion 605. The cover portion may be adapted so that it may be lowered to a covering position on the channel portion 605, or may be rotated to an open position for accessing the interior of the conduit. The cover portion 610 and channel portion 605 may be separately formed components. In alternate embodiments, the cover portion 610, hinge 685, and channel portion 605 could be constructed together as a unitary piece, such as unitary piece of extruded polymer or other plastic material. The hinge 685 may, for example, comprise a portion of the unitary piece that is sufficiently thin to allow rotation of the cover portion 610 relative to the channel portion 605. In still alternate embodiments, the conduit may have any other suitable construction.

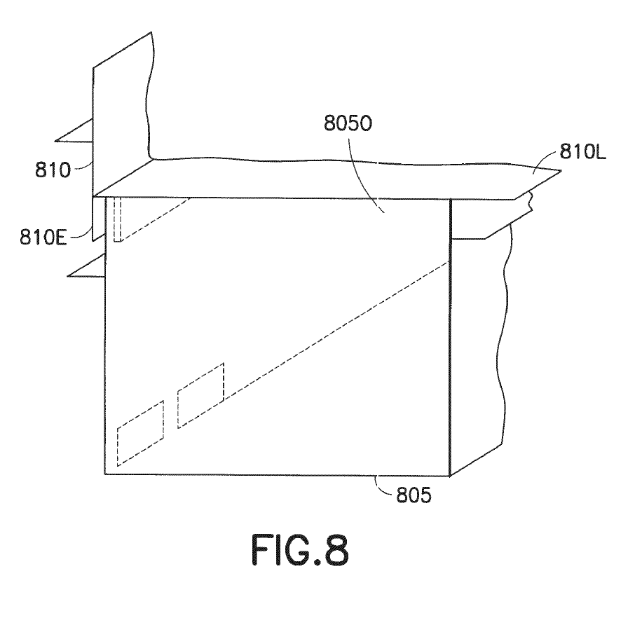

FIG. 8 illustrates a subfloor drain conduit in accordance with yet another exemplary embodiment. The drain channel section of the conduit shown in FIG. 8 is substantially similar to the drain channel sections described before. The section may include channel portion 805 and closure 810 that may be removed from the drain channel to open access opening 805O defined by portion 805. In the exemplary embodiment, the closure 810 may have engagement surfaces 810E, schematically depicted in FIG. 8 for example purposes to engage and position the closure 810 on the channel portion when closed. The engagement surfaces may be biased against contact surface on the portion 805 to frictionally hold the closure 810 onto the channel portion 805. The closure 810 may have an extension or lip 802 protecting therefrom to overlap or seat against the floor 24′ (see also FIG. 4).

It should be seen that the foregoing description is only illustrative. Various alternatives and modifications can be devised by those skilled in the art. Accordingly, the present embodiments are intended to embrace all such alternatives, modifications, and variances which fall within the scope of the appended claims.

In one embodiment, an elongate drainage conduit section comprises a channel portion having at least one perforated surface allowing liquid to flow into the channel, and at least one lower surface for directing the flow of liquid in a lengthwise direction. The elongate drainage conduit section further comprises an elongate, movable cover sealing the top of said channel to form, with the channel portion, a tubular structure. The elongate drainage conduit section still further comprises a back wall extending vertically upward from the channel portion, above and substantially perpendicular to the removable cover, and extending lengthwise along the conduit section, the back wall and channel portion being of unitary construction.

In another embodiment, an elongate drainage conduit comprises a conveying section adapted to be permanently installed in an at least partially subterranean chamber, and to convey water in a lengthwise direction, the conveying section having multiple water-inlet openings to receive water into the conveying section for drainage. The elongate drainage conduit further comprises a cover section adapted to cover at least a portion of the conveying section, the cover section having locating features adapted to interface with reciprocal locating features on the conveying section to locate the cover section in a sealing position. When the cover section is removed from the conveying section, the conveying section is substantially open to allow access to an interior of the conveying section. When the cover section is located on the conveying section in the sealing position, the conveying section is substantially closed to prevent debris from falling into the interior of the conveying section.

In yet another embodiment, a basement drainage system comprises a basement wall and a basement floor comprising cementitious material. The basement drainage system further comprises a drainage trough permanently installed at a joint between the basement wall and the basement floor and extending lengthwise along substantially the entire length of the joint, the drainage trough having a plurality of holes along its length to allow an inflow of water into the trough. The basement drainage system further comprises a trough cover system comprising at least one covering segment adapted to be removably snapped onto the drainage trough, the trough cover system being adapted to cover substantially the entire trough along substantially the entire length of the joint. The interior of the trough may be accessed for cleaning through the top of the trough at any given portion along the joint by removing one or more of the at least one covering segments.

What is claimed is:

1. A drainage conduit system for an at least partially subterranean room having a floor, the system comprising:
a subfloor drain channel arranged to be disposed under the floor when installed; and
a channel cleaning entryway through the floor for hand cleaning of the subfloor drain channel when installed, the entryway extending along a part of the length of the drain channel and communicating with an adjoining longitudinal portion of the subfloor drain channel without through floor entry adjacent the entryway and forming hand cleaning access to the subfloor drain channel and the adjoining portion.

2. The system according to claim 1, wherein the drain channel has a movable closure closing the cleaning entryway, the closure being disposed on the drain channel to be movable relative to and allow opening of the cleaning entryway when the drain channel is installed.

3. The system according to claim 2, wherein the closure is a cover removably connected to the drain channel to cover the cleaning entryway when installed.

4. The system according to claim 3, wherein the drain channel has detents for receiving and forming locking engagement with locking members of the cover locking the cover in position closing the cleaning entryway.

5. The system according to claim 1, wherein the room has the floor disposed over footings, the subfloor drain channel being arranged to be disposed over the footing and under the surface of the floor when installed.

6. The system according to claim 1, wherein the drain channel has a wall flashing with a back disposed for contacting a wall of the room, when the drain channel is installed, and defining another drain channel between the wall and wall flashing.

7. The system according to claim 6, wherein the cleaning entryway accesses the other drain channel for hand cleaning thereof.

8. The system according to claim 6, wherein the wall flashing forms a removable cover closing the cleaning entryway, the cover being disposed on the drain channel to allow removal and opening of the cleaning entryway when the drain channel is installed.

9. The system according to claim 1, wherein at least a portion of the drain channel is of unitary construction and has an opening therein forming the channel cleaning entryway, the opening being sized and shaped so that drain channel perimeter surfaces are substantially freely accessible by hand.

10. The system according to claim 1, wherein the drain channel has a projecting member for engaging the floor and stably holding a free edge of the cleaning entryway when the drain channel is installed.

11. A drainage conduit system for an at least partially subterranean room having a floor over footings and a wall, the system comprising:
a subfloor drain channel having drainage features, the channel arranged to be disposed under the floor and over the footing when installed, the drain channel comprising;
a subfloor channel section having an opening extending along part of the length of the channel and communicating with an adjoining longitudinal portion of the subfloor drain channel that is offset from and to adjacent the opening, the opening extending through the floor and allowing access through the floor for inspection of the drain channel and the adjoining longitudinal portion without through floor entry and for removal out through the opening of residue buildup in the drain channel and the adjoining longitudinal portion when the drain channel is installed; and
a closure movably connected to the subfloor channel section to close the opening, the closure being adapted to be movable relative to the channel section to open and close the opening when the drain channel is installed.

12. The system according to claim 11, wherein the closure is a cover removably connected to the drain channel to cover the cleaning entryway when installed.

13. The system according to claim 12, wherein the closure and channel section have conformal detents adapted for interlocking the channel section and closure to each other when the closure is closed.

14. The system according to claim 12, wherein the closure includes a wall flashing, the wall flashing having a back with spacers, wherein when installed, the wall flashing extends above the floor and the spacers contact the wall to form a drain channel passage between the wall flashing and wall.

15. The system according to claim 14, wherein the closure is of unitary construction and the drain channel passage is accessible for inspection and cleaning through the opening.

16. The system according to claim 11, wherein the channel section includes a wall flashing, the wall flashing having a back with spacers, wherein when installed, the wall flashing extends above the floor and the spacers contact the wall to form a drain channel passage between the wall flashing and wall.

17. The system according to claim 16, wherein the channel section is of unitary construction and the drain channel passage is accessible for inspection and cleaning through the opening.

18. A method for cleaning a subfloor drain conduit system of a partially subterranean room having a floor, the drain conduit system having a drain channel section disposed under the floor when installed, the method comprising:
providing the drain channel section with a closable opening that extends through the floor when the drain channel section is installed;
opening the closable opening; and
removing residue buildup inside the subfloor drain conduit system through the opening, the closeable opening extending along a part of the length of the drain channel section and communicating with an adjoining longitudinal portion of the drain channel section without through floor entry adjacent the closeable opening and forming access to the part of the length of the drain channel and the adjoining portion.

19. The method according to claim 18, wherein the drain channel section has walls defining a drain channel, and wherein opening the closable opening exposes for visual inspection substantially the whole width of the drain channel.

20. The method according to claim 18, wherein removing comprises hand lifting the residue buildup through the opening.
